(19) United States
(12) Patent Application Publication
(10) Pub. No.: US 2024/0286266 A1
(43) Pub. Date: Aug. 29, 2024

(54) Universal Hex Tool with Adjustable Securing Mechanism

(71) Applicant: Stanley Black & Decker Inc., New Britain, CT (US)

(72) Inventors: Christopher IBRAHIM, Fort Mill, SC (US); David P. ENGVALL, Stanley, NC (US); Angela CHEN, Taichung City (TW)

(21) Appl. No.: 18/175,199

(22) Filed: Feb. 27, 2023

(51) Int. Cl. B25G 1/00; B25G 1/08; B25G 3/22

(52) U.S. Cl. CPC B25G 1/005; B25G 1/085; B25G 3/22; B25G 1/102

(57) ABSTRACT

The invention is directed toward a tool assembly for optionally operating a tool body independently or in combination with a storage holder for polygonal shaped tools, such as a L shaped hex key. The tool assembly includes a tool main body that can act as a tool itself. The tool main body may comprise a housing, an adjustable securing mechanism, and a control member. The adjustable securing mechanism is mounted in the tool main body housing and is operatively connected with the control member. The adjusting mechanism is configured to accept and secure a tool of different sizes and shapes. The control member is rotatable to bias the adjustable securing mechanism to rotate around an axial direction in the housing so that the adjustable securing mechanism is moved in a manner to either secure a tool or release a tool.

### FIELD

The present invention relates generally to hand tools. More particularly, the present invention relates to a torque-enabling tool assembly for hex keys of various sizes.

### BACKGROUND

Many tool holders are used for hex keys, star drive keys, and other drive tools. Typically, the tools are a type of a steel bar with driving ends on one or both ends that are formed at right angles to each other with one arm being shorter than the second arm (in an L-shape) The length of the arms typically predetermined such that the tool can be used in various applications with different fastener accessibility conditions. The size of the tools is predetermined such that the size of each tool can be used for different applications or different sized applications.

Tool holders typically are a structure made of polyprolene, PVC, or rigid material with fixed or static holes for holding keys/tools. Tool key holders come in various sizes and shapes. Many holders are used to hold or store hex keys or tools without providing separate utility function in the holder. This lack of utility in tool holders creates restriction on the use of the tool holder. For example, in U.S. Pat. No. 9,193,062B2 there is shown a tool holder product that can contain a number of different keys at different sizes. Each hole can accommodate a different hex key at a location on the tool holder.

However, many of these products are not efficient in use or fail to provide the capacity for a range of polygonal shaped tools of different sizes to be stored as well as providing more functionality for different polygonal shaped tools. Additionally, the holders do not provide all the strength and meets the needs of the application adequately. Therefore, it is desirable to provide a tool holder having a dynamic and adjustable securing method that is capable of using a number of tools for different applications or different sized applications.

### SUMMARY

An object of the present invention is to solve problems with ordinary tool holders.

Another object of the present invention to obviate or mitigate at least one disadvantage of common hex key tool holders.

Another object of the present invention is to provide a hex key with an adjusting mechanism to securely affix a tool of different sizes.

Another object of the present invention is to provide a tool assembly capable of interchanging tools of different sizes between the tool main body and the storage holder and using both as one tool.

In accordance with one aspect of the present invention, there is a tool assembly for polygonal shaped tools including a housing, an adjustable securing mechanism, and a knob. The adjustable securing mechanism is mounted in the housing and is operatively connected with the knob. The adjustable securing mechanism is configured to accept and secure a tool of different sizes and shapes. The knob is rotatable to drive the adjustable securing mechanism to rotate around an axial direction in the housing so that the adjustable securing mechanism is moved in a manner to either secure a tool or release a tool.

In accordance with one aspect of the present invention, there is a tool assembly for hex wrenches including a housing, an adjustable securing assembly, and a knob. The adjustable securing assembly is mounted in the housing and is operatively connected with the knob. The adjustable securing assembly is configured to accept and secure a tool of different sizes and shapes. The knob is rotatable to drive the adjustable securing assembly to rotate around an axial direction in the housing so that the adjustable securing assembly is moved in a manner to either secure a tool or release a tool.

In another aspect, the invention is an universal tool, the universal tool including a housing having a latchable top cover wherein the latchable top cover is adapted to allow removal or insertion of one or more polygonal shaped tools within the universal tool body; and an adjustable securing assembly, the adjustable securing assembly including: at least one adjustable securing member; a control member, the control member being operatively connected to the at least one fastening element; and a chuck, the chuck having a recess or opening for placement of a polygonal shaped tool.

In another aspect, the invention is an improved tool container, the tool container including a body having a latchable top cover wherein the latchable top cover is adapted to allow removal or insertion of one or more polygonal shaped tools within the tool container body; and an adjustable securing assembly, the adjustable securing assembly including: at least one adjustable securing member; a control member, the control member being operatively connected to the at least one fastening element; and a chuck, the chuck having a recess for placement against a surface of a polygonal shaped tool.

In one aspect of the illustrated invention, the invention is a tool kit for operating one or more polygonal shaped tools, the tool kit includes a tool container, the tool container including a body having a latchable top cover; a detachable tool holder, the detachable tool holder adapted to affix to the tool kit; and an adjusting assembly, movable within the tool container, the adjusting assembly comprising one or more chucks movable between a larger open position and a smaller open position to secure a tool held within the tool container in place to prevent the polygonal shaped tool from being removed when the polygonal shaped tool is in a substantially unmovable position.

A tool assembly for operating one or more polygonal shaped tools, the tool assembly comprising a tool body, the tool body including a housing having a latchable top cover; a detachable tool holder, the detachable tool holder adapted to configured to selectively couple to the tool body; and an adjustable securing assembly, movable within the tool container, the adjustable securing assembly comprising one or more chucks movable between a larger open position and a smaller open position to secure a tool held within the tool container in place to prevent the polygonal shaped tool from being removed when the polygonal shaped tool is in a substantially unmovable position.

In another aspect, the invention is a tool holder for holding one or more polygonal shaped tools, the tool holder including a hollow tool holder housing, the tool housing configured to selectively couple to another tool holder; and a plurality of detachable members, the plurality of detachable members are configured to selectively couple to the hollow tool holder housing.

An improved tool comprising: a tool body, the tool body including a housing having a latchable top cover wherein the latchable top cover is adapted to allow removal or insertion of one or more L-shaped tools within the tool container body; and an adjustable securing assembly, the adjustable securing assembly including: at least one fastening element; a control member, the control member being operatively connected to the at least one fastening element; and a chuck, the chuck having at least one of a recess, indentation, trench, or aperture for placement against a surface of a polygonal shaped tool.

In accordance with one aspect of the present invention, there is a tool assembly for hex wrenches including a housing, an adjustable securing mechanism, and a control member. The adjustable securing mechanism is mounted in the housing and is operatively connected with the control member. The adjustable securing mechanism is configured to accept and secure a tool of different sizes and shapes. The control member is rotatable to drive the adjustable securing mechanism to rotate around an axial direction in the housing so that the adjustable securing mechanism is moved in a manner to either secure a tool or release a tool.

In accordance with one aspect of the present invention, there is a tool assembly for hex wrenches including a housing, an adjustable securing assembly, and a control member. The adjustable securing assembly is mounted in the housing and is operatively connected with the control member. The adjustable securing assembly is configured to accept and secure a tool of different sizes and shapes. The control member is rotatable to drive the adjustable securing assembly to rotate around an axial direction in the housing so that the adjustable securing assembly is moved in a manner to either secure a tool or release a tool.

In one aspect of the illustrated invention, the invention is a tool kit for operating one or more polygonal shaped tools, the tool kit includes a tool container, the tool container including a body having a latchable top cover; a detachable tool holder, the detachable tool holder adapted to affix to the tool kit; and an adjusting assembly, movable within the tool container, the adjusting assembly comprising one or more chucks movable between a larger open position and a smaller open position to secure a tool held within the tool container in place to prevent the polygonal shaped tool from being removed when the polygonal shaped tool is in a substantially unmovable position.

In another aspect, the invention is an improved tool container, the tool container including a body having a latchable top cover wherein the latchable top cover is adapted to allow removal or insertion of one or more L-shaped tools within the tool container body, and an adjustable securing assembly, the adjustable securing assembly including at least one biasing element, a control member, the control member being operatively connected to the at least one biasing element; and a chuck, the chuck having a recess for placement against a surface of a polygonal shaped tool.

In another aspect, the invention is a tool holder for holding one or more L-shaped tools each comprising a short leg and a long leg, the tool holder comprising: a hollow tool holder housing, the tool housing configured to selectively couple to another tool container; and a plurality of detachable members, the plurality of detachable members are configured to selectively couple to the hollow tool holder housing.

This implementation of the invention, in particular, may be desired, because the structure and arrangement allow for reduced rotations and/or reduced number of stops for when an element needs to be rotated consecutively.

The terminology used herein is for the purpose of describing implementations or embodiments only and is not intended to be limiting of the invention. As used herein, the singular forms, “a”, “an” and “the” are intended to include the plural forms as well, unless the context clearly indicates otherwise. It will be further understood that the root terms “can”, “include”, “can include”, “may”, and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes operation or physical, whether direct or indirect, affixed or coupled, as for example the adjustable securing mechanism is operatively connected with the control member, e.g., knob. Thus, unless specified, “connected” or “attached” is intended to embrace any operationally functional and/or utility connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying Attachments and drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying and drawings:

FIG. 1 is an exploded, perspective view of the hex tool main body according to a first embodiment of the present invention.

FIG. 2 is an exploded, perspective view of the hex tool main body according to a second embodiment of the present invention.

FIGS. 3A-3D depicts various views of the hex tool main body of FIG. 1.

FIGS. 4A-4F depicts various views of a chuck adapter according to FIG. 1.

FIG. 5A is a side, cross-view of the hex tool main body and chuck according to some embodiments.

FIG. 5B is another side, cross-view of the hex tool main body and chuck according to some embodiments.

FIG. 6A is a side view of the hex tool main body with an open top cover.

FIG. 6B is a top view of the hex tool main with a hex key according to FIG. 1.

FIG. 7A is a side view of the hex tool main body with a cross-sectioned view.

FIG. 7B is another side view of the hex tool main body with a cross-sectioned view of the adjustable securing assembly with a hex key of a smaller size.

FIG. 7C is another side view of the hex tool main body with a cross-sectioned view of the adjustable securing assembly with a hex key of a smaller size.

FIG. 7D is a perspective, cross view of the hex tool main body with a hex key.

FIG. 8 is a side view of the hex tool with a cross-sectioned view of the with a hex key of a larger size.

FIG. 9 is a bottom, cross-sectioned view of a hex tool main body.

FIG. 10 is a top view of a hex tool assembly including the winged storage holder overlapping the hex tool main body.

FIG. 11 is a top view of the winged storage holder with storage wings uncoupled from the winged storage holder.

FIG. 12A is a front view of the hex tool assembly according to some embodiments.

FIG. 12B is a front view of the hex tool assembly according to some embodiments.

FIG. 13A is a front view of the hex tool assembly according to some embodiments.

FIG. 13B is a front view of the hex tool assembly according to some embodiments.

FIG. 14 is a plurality of different exemplary shapes for selective attachment or coupling means of the detachable holder to the winged storage holder.

FIG. 15A is a perspective view of the hex tool assembly including the hex tool main body, winged storage holder and hex keys with the winged arms in a closed position with support of the present invention.

FIG. 15B is a perspective view of the hex tool assembly including the hex tool main body, the winged storage holder, and a number of hex keys the winged arms in an open position with support of the present invention.

FIG. 15C is a top view of the hex tool assembly according to FIG. 15B.

FIG. 15D is a front view of the hex tool assembly according to FIG. 15B.

FIG. 15E is a rear view of the hex tool assembly according to FIG. 15B.

FIG. 15F is another rear view of the hex tool assembly according to FIG. 15A.

FIG. 15G is a side view of the hex tool assembly according to FIG. 15A.

FIG. 16A is a perspective, rear view of the winged storage holder 200.

FIG. 16B is a back view of the winged storage holder 200.

Corresponding reference characters indicate corresponding parts throughout the several views. The exemplifications set out herein illustrate embodiments of the present invention, and such exemplifications are not to be construed as limiting the scope of the present invention in any manner.

### DETAILED DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

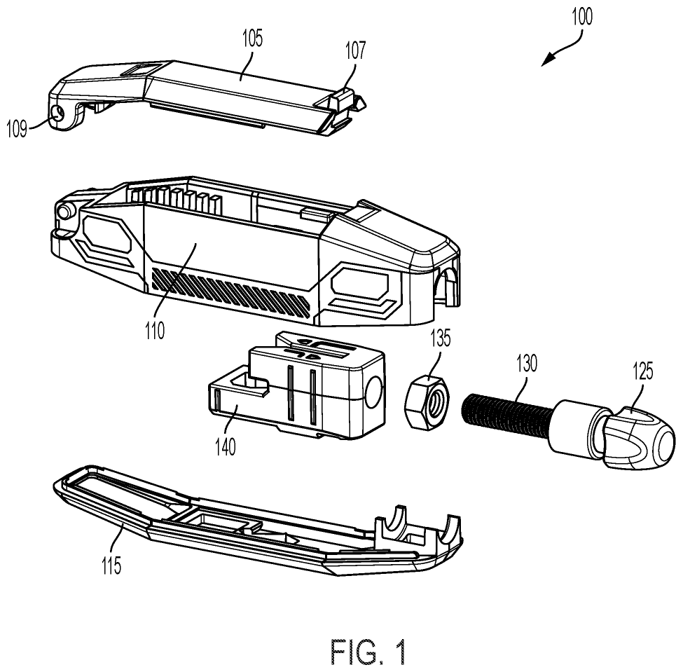

Referring to FIGS. 1-16B there is described and illustrated a plurality of figures of one embodiment of a torque-enabling universal tool main body 100 and an optional winged storage holder 200. Turning to FIG. 1, there is an exploded, perspective view of the components of the universal tool main body 100. The figure illustrates the universal tool main body 100 including a latch cover 105, tool housing 110, bottom side 115, a control member 125, a biasing element 130, a fastener 135, and a chuck 140 for holding tools, such as hex keys or allen wrenches used to actuate on bolts and screws. In this FIG. 1, there is shown the latch cover 105 having a latch 107 hingedly affixed to the cover 105 to allow for selective removal or addition of a polygonal shaped tool 175, such as a hex key, from the chuck adapter 140 inside the torque-enabling universal tool main body 100. The latch cover 105 has the latch 107 on one end of the cover 105 and hinged on at least one end to allow for selective release of a tool, such as from the chuck adapter 140. The biasing element 130 can be any member configured to be movable along an axis, e.g, push or act on the chuck 140 or can be a threaded rod as illustrated for optional tightening onto a hex key. FIG. 1 also depicts the interior of the tool main body 100 showing various sections and recesses structured to assist in securing a polygonal shaped tool.

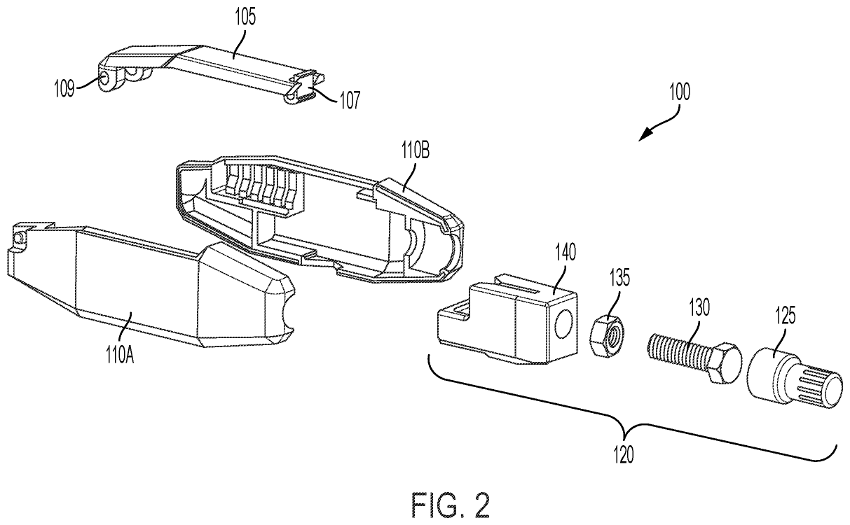

Turning to FIG. 2, there is an exploded, perspective view of components of a second embodiment universal tool main body 100. This figure illustrates the universal tool main body 100 including latch cover 105, and tool side housing 110A, 110B. The figure also illustrates the adjustable securing assembly 120 which includes the control member 125, the biasing element 130, the fastener 135, and the chuck adapter 140 for holding tools, such as hex keys or allen wrenches used to drive bolts and screws with hexagonal sockets in their heads. In this FIG. 2, there is shown the latch cover 105 having the latch 107 on one end of the cover 105 and a hinged end 109 on at least one end to allow for selective release of a hex key, such as from the chuck adapter 140. The biasing element 130 can be any member configured to push or act on the chuck 140 or can be a threaded rod as illustrated. This figure also depicts the interior of the housing 110A, 110B showing the various compartments and recesses to contain many parts of the tool main body 100.

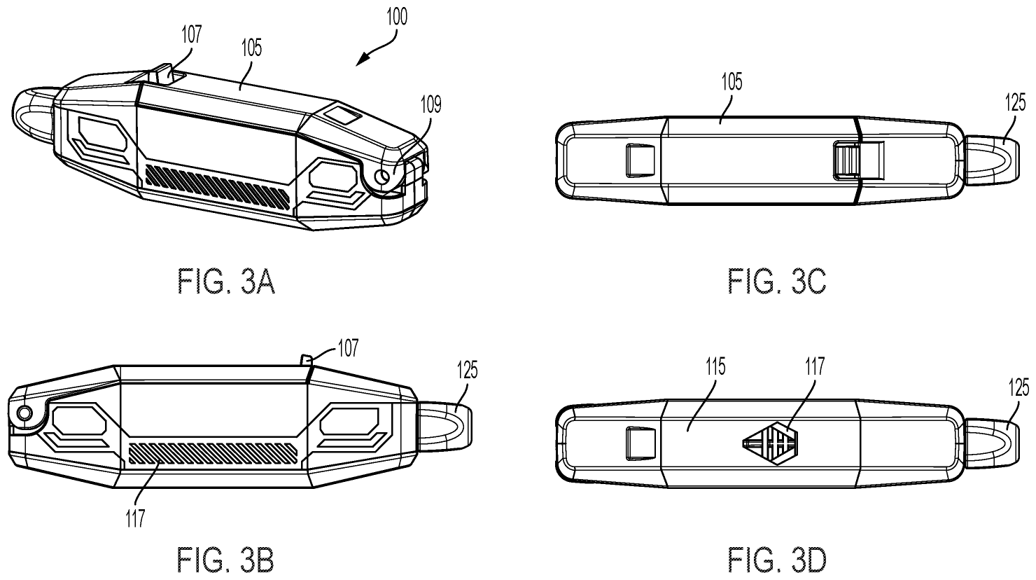

FIGS. 3A-3D depicts various views of the universal tool main body 100 of FIG. 1. Turning to FIG. 3A, there is depicted a perspective view of the hex tool main body 100. In this figure, the latchable cover 105 is illustrated in a closed position on the main body 100. FIG. 3B depicts a side view of hex tool main body 100. Illustrated in this figure, the hex tool main body 100 includes a number of markings, indentations, and/or recesses 111 configured to provide grippable surfaces for a user to operate the hex tool main body 100. Turning to FIG. 3C there is depicted a top view of the hex tool main body 100. In this illustration, the latchable cover 105 is shown flat and coupled to the hex tool 100 body. FIG. 3D there is depicted the bottom side 115 of the hex tool main body 100. The bottom side 115 of the tool body 100 includes at least one opening 117 to allow at least part of the polygonal shaped tool, e.g., hex tool, to protrude from said opening. The control member 125 can be actuated on to operate the adjustable securing assembly to be movable within the tool body 100 by making chuck 140 movable between the entire opening diameter of the bottom side 115 to a smaller opening in relation to the original opening diameter of the bottom side 115 to secure a polygonal shaped tool 175, e.g., hex tool, held within the tool main body 100.

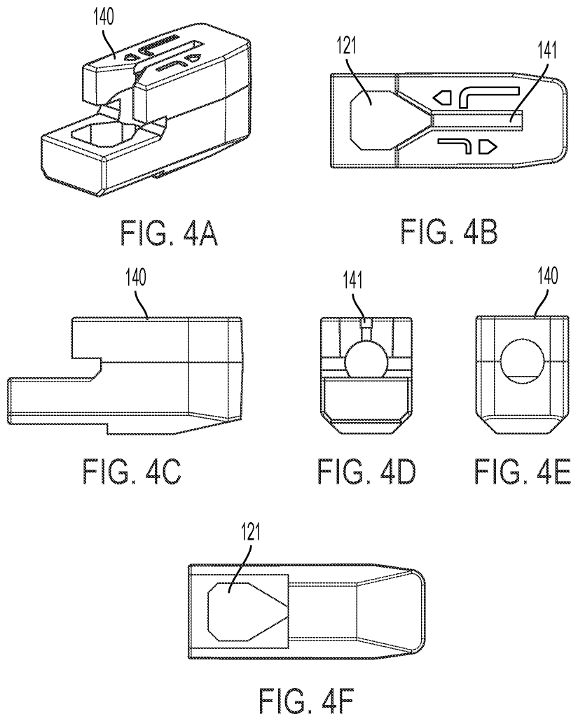

FIGS. 4A-4F depict a number of views of the chuck 140 according to some embodiments. The chuck 140 is used as the physical structure to apply the corresponding force by the plurality of engagement features on part of the hex tool 100. FIG. 4A is a perspective view of a chuck 140 according to some embodiments. In this figure, the chuck adapter 140 is shown from an angle intended to show the structure configured to receive tools of different shapes and sizes. The plurality of engagement features provide grippable surfaces of the tool to facilitate the transfer of torque to the fastener by preventing slippage between the chuck 140 and the hex tool main body 100. The figure also depicts the chuck 140 having at least one channel 141 configured to assist in preventing slippage from tools with a smaller width or length than other tools. The chuck 140 can have any number of a recesses, indentations, trenches, and apertures suitable to prevent slippage from tools with different widths or sizes.

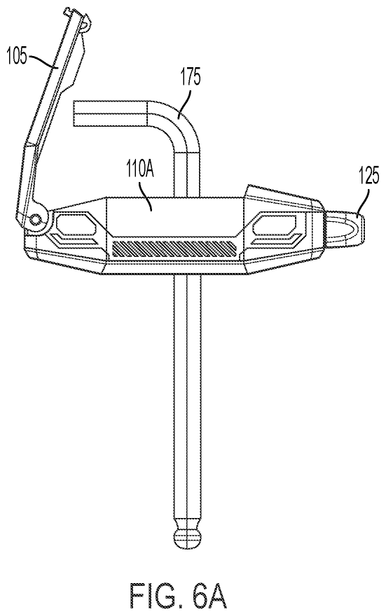

FIG. 4B is a top view of a chuck 140 according to some embodiments. In this figure, the chuck 140 is accessed (such as the latch cover 105 open in FIG. 6A). The chuck 140 may include a narrow channel 141 configured plurality of hex keys of the top surface of the chuck 140. The top surface of the chuck 140 may also include a number of markings or markers for user identification of where to place a polygonal shaped tool 175 into an aperture 121 of the chuck 140. The aperture 121 is illustrated as a structured shape such as a multiple-sided polygon configured to receive at least one hex key 175. The aperture 117 is also configured to overlay the aperture 117 of the hex tool 100. FIG. 4C is side view of the chuck 140. The side view of the chuck 140 depicts a top half that extends partially along the length of the chuck 140 and a bottom half that extends along the full length of the chuck 140. The side view also depicts a partial cut in the side wall and/or top portion of the chuck 140.

Now referring to FIG. 4D there is a front view of the chuck 140. In this view, the chuck 140 is shown having an opening substantially in the center of the apparatus along the length of the tool. The front view also depicts the top half of the chuck 140 having an angled recess in the middle of the top half that extends partially along the length of the chuck 140 as shown in FIG. 4C. Now referring to FIG. 4E shows the rear view of the chuck 140. In this view, the opening is shown as a circular opening to receive a constrictive or adjustable securing assembly 120, the constrictive assembly or adjustable securing assembly may include the control member 125, the biasing element 130 and the chuck 140. In some embodiment, the constrictive or adjustable securing mechanism may also include the fastener 135 for increased tool 100 stability and securement but the adjustable securing mechanism may also operate without the fastener 135. While the constrictive assembly or adjustable securing assembly 120 may be operate in the current embodiment and include an arrangement to include a fastener 135, biasing element 130 and a control member 125, it is not limited in this regard and any combination of parts configured to selectively secure or unsecure a polygonal shaped tool 175, such as a hex key, into the chuck 140 of the hex tool main body 100. Turning to FIG. 4F there is depicted a bottom view of a chuck 140 according to some embodiments. The chuck 140 illustrated shows the bottom view of the chuck 140 and depicts the structured aperture 121, such as a multiple-sided polygon configured to receive at least one hex key.

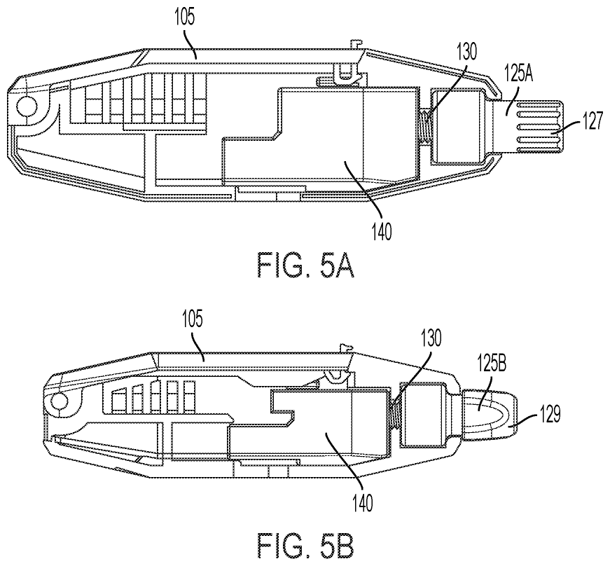

FIG. 5A is a side, cross-view of the assembled hex tool main body 100 of FIG. 1 according to some embodiments. In this figure the hex tool main body 100 is shown in the closed position. The control member 125A is one illustrated variation of a knob with ridges 127 that is coupled to the biasing element 130 and the chuck 140. This figures also illustrates an inner structure adapted to accept hex or L shaped tools of different sizes. FIG. 5B is another side, cross-view of the assembled hex tool main body 100 according to some embodiments. In this figure the hex tool main body 100 is also shown in the closed position. The control member 125B is another illustrated variation of a knob with a recessed surface 129 that is coupled to the biasing element 130 and the chuck 140.

FIG. 6A is a side view of the hex tool main body 100 with an open top cover 105. In this figure there is illustrated the hex tool main body 100 with the latch cover 105 in an open position, for holding polygonal shaped tools 175, such as hex keys or allen wrenches used to drive or remove fasteners, bolts, and screws. The figure also depicts one side of the tool body 110A, and the control member 125. In this figure, the tool 175 is shown with the top cover 105 open and the tool 175 partially inserted into the aperture 121 of the chuck 140.

FIG. 6B is a top view of the hex tool main body 100 with an open top cover 105, such as shown in FIG. 6A. In FIG. 6B, there is illustrated the hex tool main body 100 with the latch cover 105 in an open position. The figure also depicts both sides of the tool body 110A, 110B and the control member 125. In this figure, the tool 175 is shown with the top cover 105 open and the tool 175 partially inserted into the chuck adapter 140. In this view, a larger hex key 175 is inserted according to the markers as depicted on the top of the chuck adapter 140 and the shorter arm of the hex key 175 is placed into a hollow area of the hex tool main body 100.

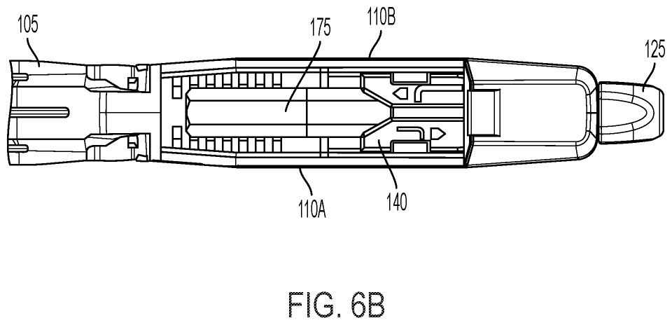

FIG. 7A is a side view of the hex tool main body 100 with a hex key 175 according to some embodiments. In this figure the hex tool main body 100 is also shown in the closed position. The control member 125A of FIG. 5A is depicture coupled to the biasing element 130 and the chuck 140 containing the tool 175. The fastener 135, such as a bolt, may be operatively connected to the control member 125A to allow the user to press on, bias, or act on the chuck 140 to secure a polygonal shaped tool.

FIG. 7B is another side view of the hex tool 100 with a cross-sectioned view of the chuck 140 according to some embodiments. In this figure the hex tool main body 100 is also shown in the closed position with the latch cover 105 selectively affixed to the hex tool 100 by the latch 107. The control member 125B of FIG. 5B is depicture coupled to the biasing element 130 and the chuck 140 containing the polygonal shaped tool 175.

FIG. 7C is a side view of the hex tool main body 100 with a cross-sectioned view of the chuck 140 according to some embodiments. In this figure, the control member 125 is shown coupled or affixed to the biasing element 130. The polygonal shaped tool 175 is shown included in the channel 141 of the chuck adapter 140 and extending out of the aperture 117 of the tool main body 100.

FIG. 7D is a side view of the hex tool main body 100 with a cross-sectioned view of the chuck 140 according to some embodiments. In this figure the hex tool assembly 100 is also shown in the closed position with the latch 107 secured to the housing 110. In this Figure, the tool 175 is shown partly inserted into the chuck 140 and extending out of the aperture 117 of the tool assembly 100. In this illustration the tool is shown in an alternate placement direction than shown in FIGS. 7A-7C.

The adjustable securing assembly 120 includes the chuck 140, the control member or control 125, the bolt, and the biasing element 130, which arranged together are configured to provide a movable mechanism to secure a plurality of polygonal or hex shaped tools 175 of various sizes inside the universal tool main body 100 to provide for user operation. An exemplary functional use of the adjustable securing assembly 120 may be a user placing a force on the control member 125 to actuate on or operate the adjustable securing assembly 120 to be movable within the tool body 100 by making the chuck 140 movable from one side the entire opening diameter of the bottom side 115 to a smaller or reduced operational opening in relation to the original opening diameter of the bottom side 115 to secure a polygonal shaped tool 175, e.g. hex tool, held within the tool body 100. The adjustable securing assembly 120 may also be configured to secure a plurality of hex shaped tools having distal ends of different shapes for a corresponding fastener. In some embodiments, the control member, exemplary knob, has different shapes, structures, markings, recesses, or indentations.

The adjustable securing assembly 120 is one of the different unique features of the hex tool 100. The structure of the adjustable securing assembly 120 arranged together is configured to provide a movable mechanism 140 to secure a plurality of polygonal or hex shaped tools 175 of various sizes inside the tool housing 100 to provide for user operation of a large. Some advantageous uses of the adjustable securing assembly 120 is that the chuck 140 in the adjustable securing assembly 120 allows for secure placement of many and various sized hex keys 175 without need for another tool or tool holder.

At least one side of the hex tool main body or housing 100 includes at least one opening to receive at least a part of a detachable storage holder 200 in order to selectively couple or uncouple the hex tool main body 100 and the detachable storage holder 200. The openings on at least one surface of the hex tool body 100 are configured to allow coupling and decoupling of the hex tool main body 100 and the detachable storage holder 200. The manner of selective coupling and decoupling can be latching, fastening, screwing, or any functional male to female coupling. The opening on the hex tool main body 100 can be any of a holding tube, pocket, aperture, recess, channel or socket, and wherein in order to couple one of winged storage holder 200 to the hex tool main body 100.

The hex tool assembly 300 is a universal tool that can house, contain, and operate various tools, such as hex keys, taps and reamers, allen wrenches, of many diverse sizes including metric and SAE. The common metric sizes typically range from 1.5 mm (displayed as 1.5M) to 10 mm (displayed as 10M) but can include any size able to fit within the hex tool 100.

Some of the unique advantages of the hex tool main body 100 includes providing means and method for securing a number of hex keys of various sizes and shapes. The hex tool main body 100 further provides strength and stability to user operation irrespective of the size of the hex key 175 placed in the chuck 140. These added benefits of allowing user operation of the smallest of hex keys such as for use on eyeglass fasteners to larger hex keys such as for use on furniture assembly.

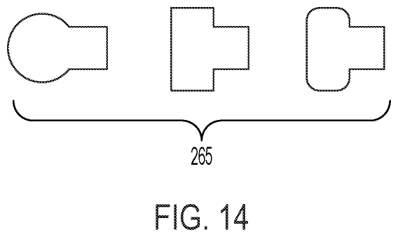

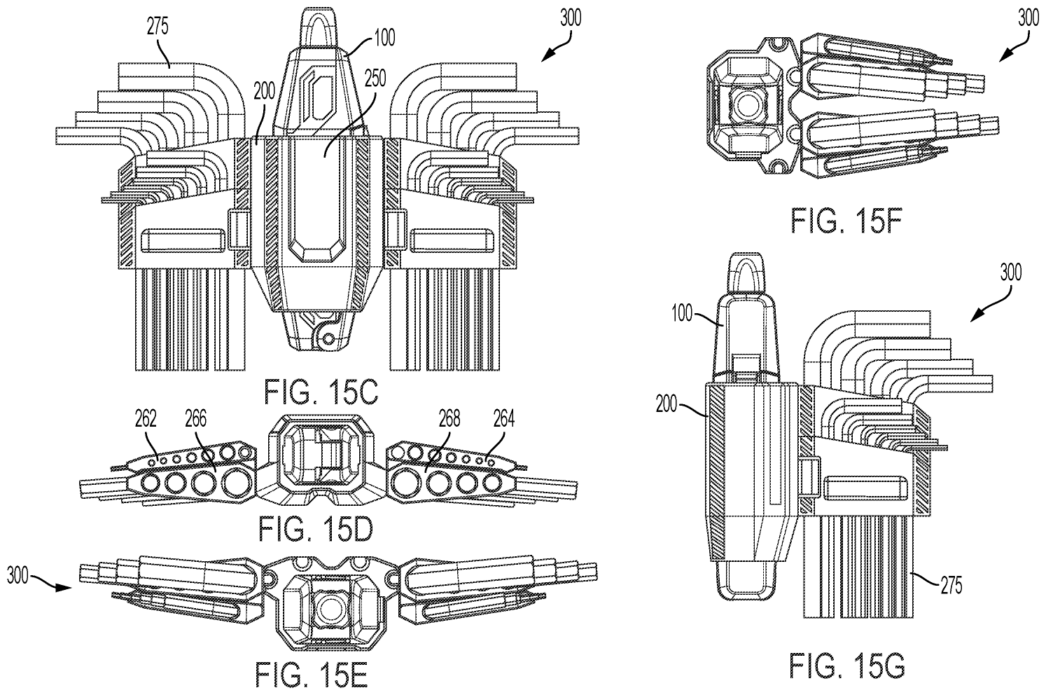

The detachable wings 260 may include singular wings such as detachable arms 262, 264 but may include more arms, such as arms 262, 264, 266, 268. Each arm is adapted to contain or hold at least one tool, such as a hex key or allen wrench, but is not limited in this regard and may include multiple tools on each arm as shown in FIG. 15B. Each detachable arm 262, 264, 266, 268 of the winged storage holder 200 may be separate or coupled together to form a detachable wing 260, such as shown in exemplary hinged coupling of arms in FIG. 13D. Each wing may be selectively coupled to the holder housing 250 by attachment means 265.

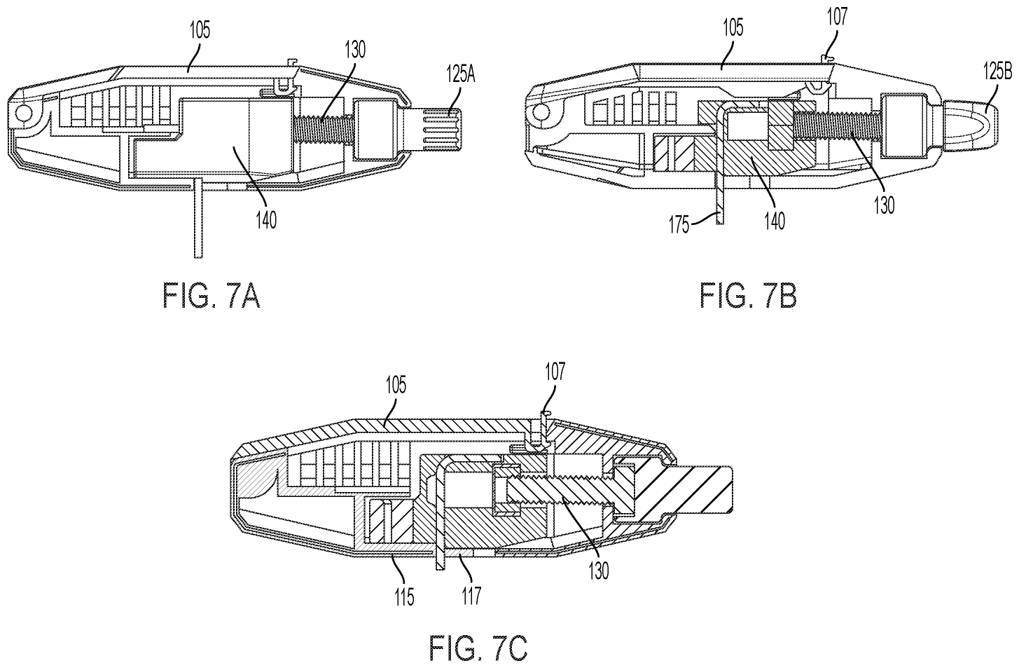

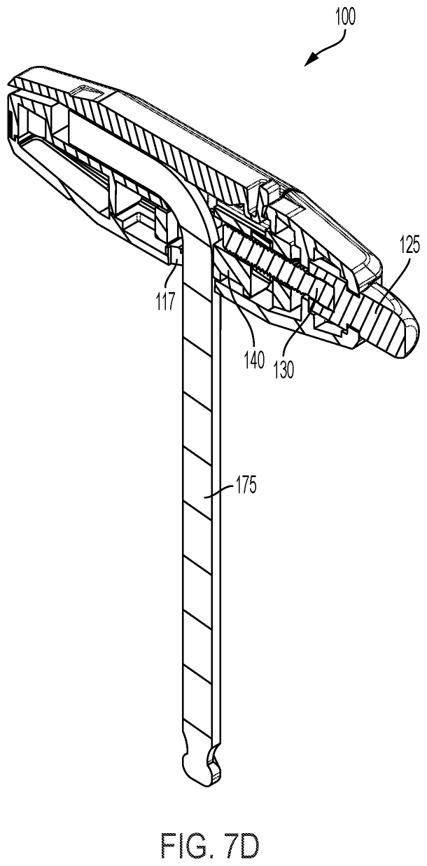

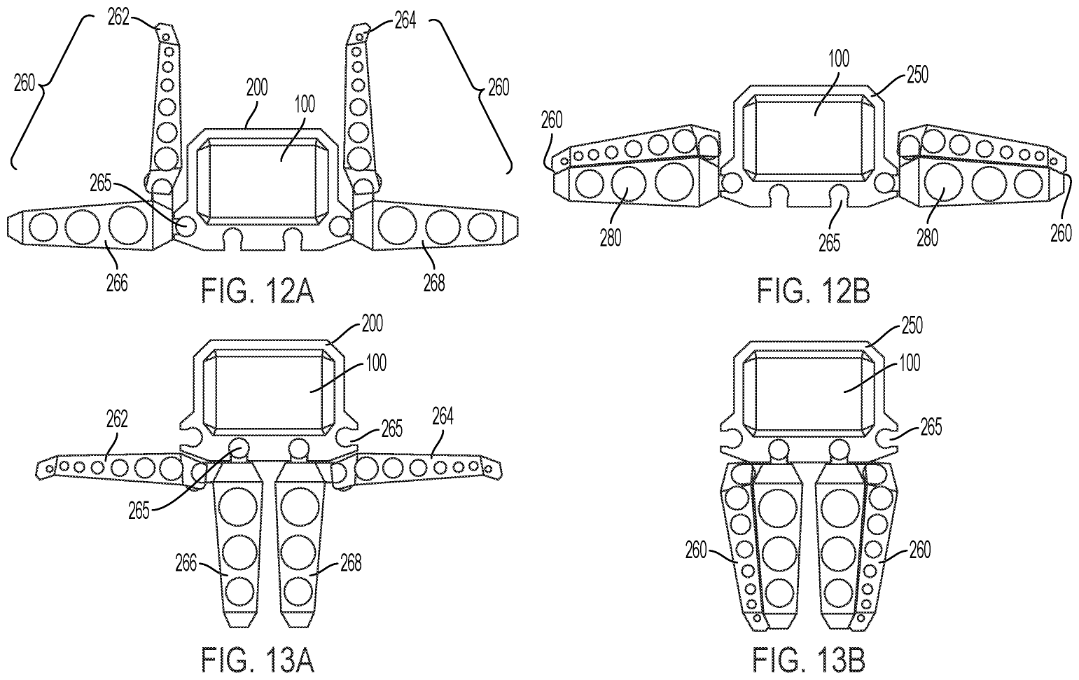

FIG. 8 is a side, internal view of the winged storage holder 200 overlapping the hex tool main body 100. In this Figure, the winged storage holder 200 is depicted extending outward from the center and the hex tool main body 100 included in an opening of the storage holder 200. FIG. 9 is bottom view of the winged storage holder 200 of FIG. 8 with the storage wings 220 disengaged from the winged storage holder 200. In this figure, the storage wings 220A, 220B are shown unattached to the winged storage holder 200 such as a user pushing or pulling the wings 220A, 220B from a plurality of different shapes configured for selectively connecting the storage wings 220A, 220B to the winged storage holder 200 (see FIG. 12).

FIG. 9 is a partial cross-sectioned, bottom view of a hex tool main body 100 including a tool 175. As shown in this figure, there is illustrated the bottom view of FIG. 6. In this figure, the hex tool main body 100 is partly cross-sectioned to illustrate arrangement of the components. There is also shown a bottom cover 115 and the aperture 117 in the bottom cover 115 to allow the tool 175 for use out of the hex tool main body 100.

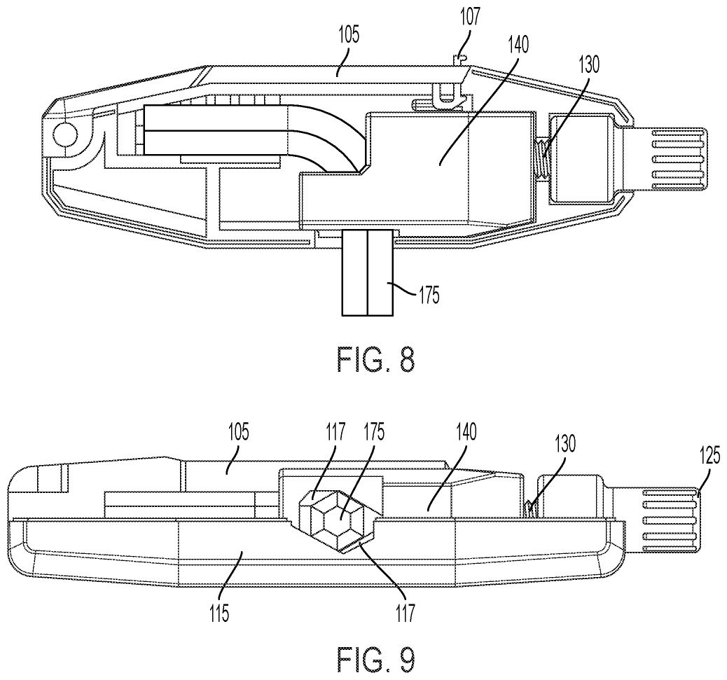

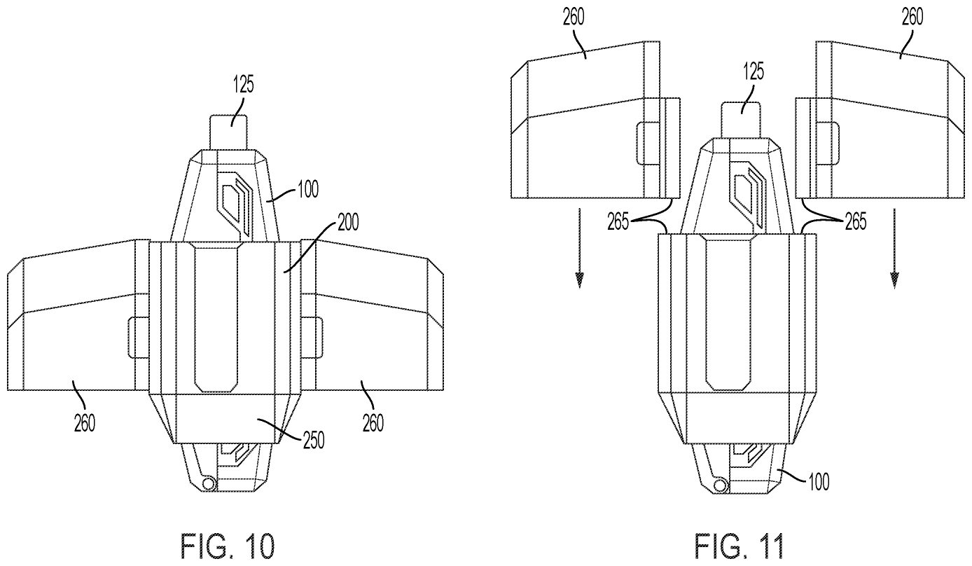

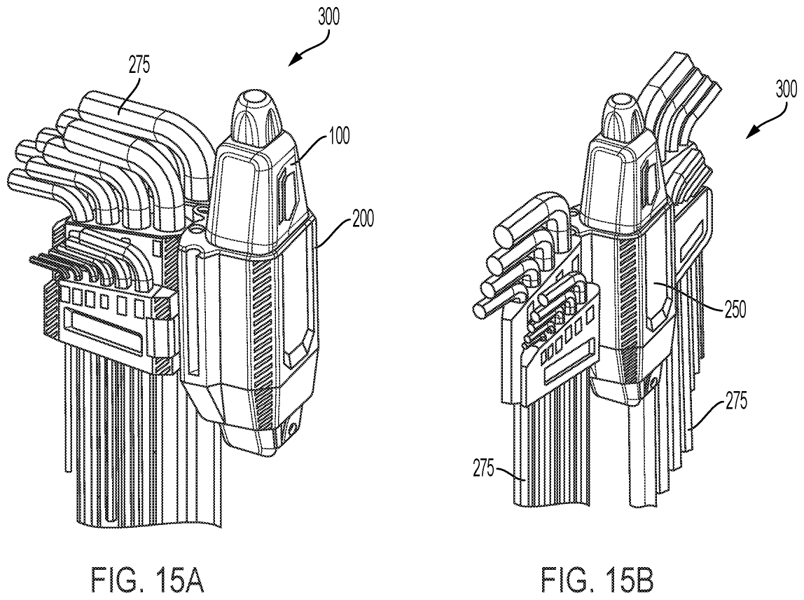

FIG. 10 is a top view of the winged storage holder 200 according to some embodiments. In this figure, the winged holder 200 includes a holder housing 250, a pair of wings 260, and attachment means 265. The holder housing can be a separate housing detached from the pair of wings 260. Turning to FIG. 11, the wings 260 are depicted coupled to the bottom surface of the holder housing 250. The holder housing 250 is primarily comprised of a polycarbonate housing having an opening configured to contain a hex tool assembly 100. Each wing also includes a number of openings 280 configured to contain a polygonal shaped tool, such as a L shaped tool, hex key (SAE or metric size), tap and reamer, and allen wrench. In both FIGS. 10 & 11, the holder housing 250 may include a number of attachment means 265 for connecting the plurality of wings 260 to the holder 200 (See FIG. 14).

Each wing 260 in the winged storage holder 200 includes selective attachment or coupling 265 for optional attachment of the wings 260 to the holder housing 250. A storage wing 260 has a number of arms, such as one primary wing, but can have any number of arms on each wing such as illustrated arms 262, 264 for example. Arms 264, 268 other than the primary arms 262, 266 may be attached to each wing by a hinged connected to the primary arms 262, 266.

Turning now to FIGS. 12A-13B, the arms 262, 264 266, 268 of the storage wings 260 are placed stacked together. Each of the wings 260 are selectively connectable to the holder housing 250 by attachment means 265 in the same attachment means configurations, such as shown in FIGS. 11-13B. Now referring to FIG. 14 is a plurality of different shapes 265 for operatively connecting the storage wings 260 to the winged storage holder 200.

The shape of the attachment means 265 can be any shape configured for male-to-female coupling between the hex tool main body 100 and the winged storage holder 200, such as at least one surface of the hex tool main body 100 having a female opening to receive a corresponding male protrusion from at least one detachable member from the winged storage holder 200. The attachment means 265 may be any shape including at least one of a recessed sphere, cylinder, triangular, cuboid, or polygonal shape configured to selective slide, latch, or affix at least one detachable arm to the winged storage holder 200.

FIGS. 15A-15F are a number of views of the attached hex tool assembly 300 and winged storage holder 200 with support of the present embodiment. Each figure depicts the hex tool main body 100 contained within the holder housing 250 of the winged holder 200. Each arm 262, 264, 266, 268 is depicted containing a number of polygonal shaped tools 275, such as L shaped tools or hex keys, contained within the openings 280 shown in FIG. 12B.

As shown in FIGS. 15A-15F, the storage wings 260 act as storage for a plurality of keys for use with the hex tool main body 100. The hex tool main body 100 is held within the winged storage holder 200 to allow user easy access and quick change of tool 275 sizes.

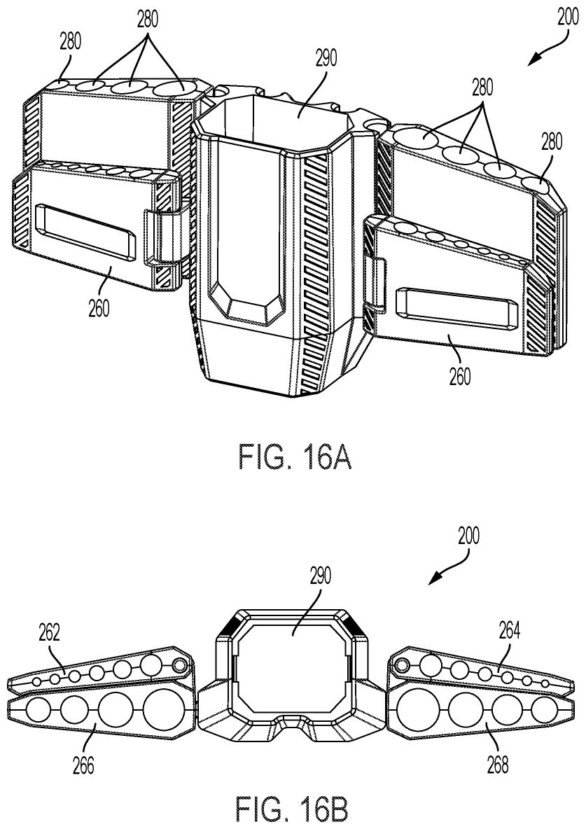

FIG. 16A is a perspective, rear view of the winged storage holder 200. The figure shows each detachable arm 262, 264, 266, 268 placed together to form amalgamated single detachable wings 260. FIG. 16A also depicts the storage holder 200 having an opening 290 adapted to selectively attach onto the hex tool main body 100. Referring to FIG. 16B there is illustrated a back view of the winged storage holder 200. FIG. 16B shows another view of the detachable arm members 262, 264, 266, 268 placed together to form amalgamated single detachable wings 260. The figure also depicts the opening 290 of the storage holder 200 in an exemplary horizontal axis to provide access for the hex tool main body 100 to be placed into the opening 290 of the storage holder 200 to form the hex tool assembly 300 as shown in FIG. 15A.

While it is anticipated that the universal tool main body 100 will be in operational use with both the storage holder 200, it is not limited and the tool main body 100 may be operationally used without the storage holder 200. It will be understood by one skilled in the art that the drive tool main body may be removed from the holder individual use or when the user requires use of the end of the smaller portion of a drive tool.

While certain features of the described implementations have been illustrated as described herein, many modifications, substitutions, changes and equivalents will now occur to those skilled in the art. It should be noted that the present invention may, however, be embodied or combined in many different forms and should not be construed as limited to the embodiments set forth herein; rather, the embodiments set forth herein are provided so that the disclosure will be thorough and complete, and will fully convey the scope of the invention to those skilled in the art. Furthermore, any steps and number of the various steps illustrated in the figures may be adjusted from that shown. The accompanying figures and attachments illustrate exemplary embodiments of the invention.

It is, therefore, to be understood that any claims and/or descriptions are intended to cover all such modifications and changes as fall within the scope of the implementations. It should be understood that they have been presented by way of example only, not limitation, and various changes in form and details may be made. Those skilled in the art will appreciate that various adaptations and modifications of the example and alternative embodiments described above can be configured without departing from the scope and spirit of the invention. Therefore, it is to be understood that, within the scope of the summaries and/or descriptions, the invention may be practiced other than as specifically described herein.

We claim:

1. A universal tool comprising:
a main tool body, the tool body including a housing having a latchable top cover wherein the latchable top cover is adapted to allow removal or insertion of one or more polygonal shaped tools within the main tool body; and
an adjustable securing assembly, the adjustable securing assembly including:
at least one fastening element;
a control member, the control member being operatively connected to the at least one fastening element; and
a chuck, the chuck having a recess for placement against a surface of a polygonal shaped tool.

2. The universal tool of claim 1, wherein the housing of the tool body includes at least one side having an opening to allow at least part of the polygonal shaped tool to protrude from said opening.

3. The universal tool of claim 1, wherein the adjustable securing assembly is movable within the tool body, the adjustable securing assembly includes one or more chucks is movable between a larger open position and a smaller open position in relation to the at least one side having an opening to secure a polygonal shaped tool held within the tool body.

4. The universal tool of claim 1, wherein the adjustable securing assembly is movable within the tool body, the adjustable securing assembly includes one or more chucks is movable between a larger open position and a smaller open position in relation to the at least one side having an opening to prevent the polygonal shaped tool from being removed when the polygonal shaped tool is in a substantially unmovable position.

5. The universal tool of claim 1, wherein the adjustable securing assembly further comprises the chuck having at least one surface wherein a polygonal shaped tool can be secured within said surface.

6. The universal tool of claim 1, wherein the latchable top cover is hingedly affixed to the tool container body to allow removal or insertion of one or more polygonal shaped tools within the tool body.

7. A tool assembly for operating one or more polygonal shaped tools, the tool assembly comprising:
a tool body, the tool body including a housing having a latchable top cover;
a detachable tool holder, the detachable tool holder adapted to attach to the tool body; and
an adjustable securing assembly, movable within the tool container, the adjustable securing assembly comprising one or more chucks movable between a larger open position and a smaller open position to secure a tool held within the tool container in place to prevent the polygonal shaped tool from being removed when the polygonal shaped tool is in a substantially unmovable position.

8. The tool assembly of claim 7, wherein the housing of the tool body includes at least one side having an opening to allow at least part of the polygonal shaped tool to protrude from said opening.

9. The tool assembly of claim 7, wherein the adjustable securing assembly further comprises the chuck having at least one surface wherein a polygonal shaped tool can be secured within said surface.

10. The tool assembly of claim 7, wherein the tool holder has a number of winged members selectively connectable to the detachable tool holder.

11. The tool assembly of claim 7, wherein the tool holder has a number of detachable members.

12. The tool assembly of claim 11, wherein each detachable member of the tool holder includes a number of openings configured to retain at least one polygonal shaped tool.

13. The tool assembly of claim 11, wherein the tool holder and at least one detachable member is selectively coupled together by male to female attachment.

14. The tool assembly of claim 7, wherein the tool holder includes an opening configured to contain the tool body within at least one part of the tool holder.

15. A tool holder for holding one or more polygonal shaped tools, the tool holder comprising:
a hollow tool holder housing, the tool housing configured to selectively couple to another tool body; and
a plurality of detachable members, the plurality of detachable members are configured to selectively couple to the hollow tool holder housing.

16. The tool holder of claim 15, wherein the tool holder includes a number of detachable arm members selectively connectable to the tool holder.

17. The tool holder of claim 15, wherein each detachable arm member of the tool holder includes a number of openings configured to retain at least one polygonal shaped tool.

18. The tool holder of claim 15, wherein each detachable arm member includes a plurality of tool retainers each comprising one of a holding tube, pocket, aperture, or socket, and wherein in order to secure one of the polygonal shaped tools into the tool holder, an end of the polygonal shaped tool is inserted into one of the plurality of tool retainers.

19. The tool holder of claim 15, wherein at least one detachable arm member is selectively connected to the tool holder by one of a recessed sphere, cylinder, triangular, cuboid, or polygonal shape.

20. The tool holder of claim 15, wherein the tool holder and at least one detachable arm member are selectively coupled together by male to female engagement.
